(19) United States
(12) Patent Application Publication
(10) Pub. No.: US 2018/0218058 A1
(43) Pub. Date: Aug. 2, 2018

(54) DATA SYNCHRONIZATION METHOD AND SYSTEM

(71) Applicant: ALIBABA GROUP HOLDING LIMITED, George Town (KY)

(72) Inventor: Yi LIU, Hangzhou (CN)

(21) Appl. No.: 15/936,313

(22) Filed: Mar. 26, 2018

Related U.S. Application Data
(63) Continuation of application No. PCT/CN2016/098960, filed on Sep. 14, 2016.

(30) Foreign Application Priority Data
Sep. 24, 2015 (CN) 201510617820.X

(51) Int. Cl. G06F 17/30; G06F 9/48; G06F 11/16; G06F 9/50

(52) U.S. Cl. CPC G06F 17/30575; G06F 9/4881; G06F 2201/80; G06F 9/5027; G06F 9/4856; G06F 11/1662

(57) ABSTRACT

Embodiments of the present application provide a data synchronization method and system. The method includes: assigning a first task for a data fragment in a target data set; starting a task thread of the first task to execute data synchronization of the corresponding data fragment between a source end and a destination end; determining if the first task corresponding to a data fragment fails in the offline data synchronization and if the first task supports a failover operation; in response to the first task corresponding to the data fragment failing in the data synchronization and the first task supporting the failover operation, clearing processing resources of the data fragment corresponding to the failed first task; and reassigning a second task for the data fragment corresponding to the failed first task, and starting a task thread of the reassigned second task to execute the data synchronization of the data fragment between the source end and the destination end.

### CROSS REFERENCE TO RELATED APPLICATION

The disclosure claims the benefits of priority to International Application No. PCT/CN2016/098960, filed on Sep. 14, 2016, which is based on and claims the benefits of priority to Chinese Application No. 201510617820.X, filed on Sep. 24, 2015, both of which are incorporated herein by reference in their entireties.

### TECHNICAL FIELD

The present application relates to the field of data processing technologies, and in particular, to a data synchronization method and a data synchronization system.

### BACKGROUND

With the development of network technologies, interactions between different databases or file systems are ever increasing. However, there are various types of databases and file systems; therefore reading and writing data among different types of databases/file systems generally occur.

When data reading and writing are performed among a number of different types of databases/file systems (e.g., when importing and exporting data), offline synchronization can be executed sometimes. It takes a long period to perform the offline synchronization, and the process of the offline synchronization can heavily depend on the reliability of a source end, an execution gateway, a destination end, and the like. In the process, one task may be divided into multiple task fragments for processing. If a fragment fails to be synchronized, however, the whole task can be failed, and synchronization results of other fragments will not be reserved. If the above fragment synchronization failure occurs, it is generally necessary to reprocess the whole task, thereby wasting resources and affecting the operating time.

### SUMMARY

The embodiments of the present application provide a more efficient data synchronization method and system.

In some embodiments, a data synchronization method is disclosed. The data synchronization method includes assigning a first task for a data fragment in a target data set; starting a task thread of the first task to execute data synchronization of the corresponding data fragment between a source end and a destination end; determining if the first task corresponding to a data fragment fails in the data synchronization and if the first task supports a failover operation; in response to the first task corresponding to the data fragment failing during the data synchronization and the first task supporting the failover operation, clearing processing resources of the data fragment corresponding to the failed first task; and reassigning a second task for the data fragment corresponding to the failed first task, and starting a task thread of the reassigned second task to execute the data synchronization of the data fragment between the source end and the destination end.

In some embodiments, determining if the first task supports the failover operation includes: in response to at least one of a read feature and a write feature of the destination end meeting the failover condition, determining that the failed first task supports the failover operation.

In some embodiments, the method further includes: in response to at least one of a read feature and a write feature of the destination end being a temporary synchronization feature or an idempotent feature, determining that the read/write feature of the destination end meets the failover condition, wherein the temporary synchronization feature includes a feature of: writing synchronization data into a temporary region in a synchronization process, and after the synchronization is completed, validating the synchronization data after the synchronization data in the temporary region is moved into a fixed storage region through an operation instruction; and the idempotent feature includes that a data writing operation supporting an idempotent operation.

In some embodiments, clearing processing resources of the data fragment corresponding to the failed first task includes: releasing resources of the task thread corresponding to the failed first task, and deleting statistical data of the data fragment corresponding to the failed first task.

In some embodiments, the task thread includes a read thread and a write thread; and the releasing resources of the task thread corresponding to the failed first task further includes: clearing synchronization data stored in data buffers corresponding to the read thread and the write thread; and canceling occupation of the read thread and the write thread by the failed data fragment corresponding to the failed first task.

In some embodiments, before clearing processing resources of the data fragment corresponding to the failed first task, the method further includes: stopping the task thread from executing the data synchronization between the source end and the destination end.

In some embodiments, the method further includes: detecting abnormal information, wherein the abnormal information comprises: source end abnormal information, destination end abnormal information, network abnormal information, and task thread abnormal information; in response to the detected abnormal information, feeding back processing failure information; and determining, according to the processing failure information, that a task corresponding to the abnormal information fails during the data synchronization.

The embodiments of the present application further disclose a data synchronization system. The data synchronization system can include: a task assignment module configured to assign a first task for a data fragment in a target data set, and reassign a task for a data fragment corresponding to a failed task; a data synchronization module configured to start a task thread of the first task to execute data synchronization of the corresponding data fragment between a source end and a destination end; and a failover module configured to, determine if the first task corresponding to a data fragment fails in the data synchronization and if the first task supports a failover operation; in response to the first task corresponding to the data fragment failing during the data synchronization and the failed first task supporting the failover operation, clear processing resources of the data fragment corresponding to the failed task, and trigger the task assignment module to reassign a second task for the data fragment corresponding to the failed first task and start a task thread of the reassigned second task to execute data synchronization of the data fragment between the source end and the destination end.

In some embodiments, the failover module includes a failover support determination sub-module configured to, in response to at least one of a read feature and a write feature of the destination end meeting a failover condition, determine that the failed first task supports the failover operation.

In some embodiments, the failover support determination sub-module is further configured to, in response to at least one of the read feature and the write feature of the destination end being a temporary synchronization feature or an idempotent feature, determine that at least one of the read feature and the write feature of the destination end meets the failover condition, wherein the temporary synchronization feature includes a feature of: writing synchronization data into a temporary region in a synchronization process, and after the synchronization is completed, validating the synchronization data after the synchronization data in the temporary region is moved into a fixed storage region through an operation instruction; and the idempotent feature includes that a data writing operation supporting an idempotent operation.

In some embodiments, the failover module includes a resource clearing sub-module configured to release resources of the task thread corresponding to the failed first task, and delete statistical data of the data fragment corresponding to the failed first task.

In some embodiments, the resource clearing sub-module is further configured to clear synchronization data stored in data buffers corresponding to a read thread and a write thread; and cancel occupation of the read thread and the write thread by the data fragment corresponding to the failed task.

In some embodiments, the resource clearing sub-module is further configured to stop execution of offline data synchronization between the source end and the destination end by the task thread.

In some embodiments, the system further includes a failure determination module configured to, detect abnormal information, wherein the abnormal information comprises: source end abnormal information, destination end abnormal information, network abnormal information, and task thread abnormal information; in response to the detected abnormal information; in response to the detected abnormal information, feedback processing failure information; and determine, according to the processing failure information, that a task corresponding to the abnormal information fails during the data synchronization.

Therefore, the data fragment of the failed task can be resynchronized, and it is unnecessary to reprocess the whole target data set, thereby saving resources and shortening the synchronization time.

### BRIEF DESCRIPTION OF THE DRAWINGS

FIG. 1 is a flowchart of an exemplary data synchronization method according to embodiments of the present application.

FIG. 2 is a flowchart of another exemplary data synchronization method according to embodiments of the present application.

FIG. 3 is a structural block diagram of an exemplary data synchronization system according to embodiments of the present application.

FIG. 4 is a structural block diagram of another exemplary data synchronization system according to embodiments of the present application.

### DETAILED DESCRIPTION

To make the above objectives, features and advantages of the present application more apparent and comprehensible, the present application is further described in detail through the accompanying drawings and specific implementations.

Embodiments of the present application provide a data synchronization method and system to solve the synchronization failure problem in data synchronization. For instance, a task can be assigned to each data fragment of a target data set respectively. A task thread of the task can be started, and offline data synchronization of the corresponding data fragment can be executed between a source end and a destination end.

In some embodiments, the task can support a failover operation, so that the task can be switched to a standby resource (e.g., a database, an application service, a hardware device, and the like in the field of computers) for further execution. The switching of a task to the standby resource can be referred to as a task-level failover. If it is determined that a task corresponding to any data fragment fails in synchronization and it is determined that the failed task supports a failover operation, processing resources of the data fragment corresponding to the failed task can be cleared and a new task can be reassigned to the data fragment corresponding to the failed task. And a task thread of the reassigned new task can then execute offline data synchronization of the data fragment between the source end and the destination end. Therefore, when the synchronization of the data fragment fails, the task-level failover can be executed to resynchronize the failed data fragment. Therefore, it is unnecessary to reprocess the target data set, thereby saving resources and shortening the synchronization time.

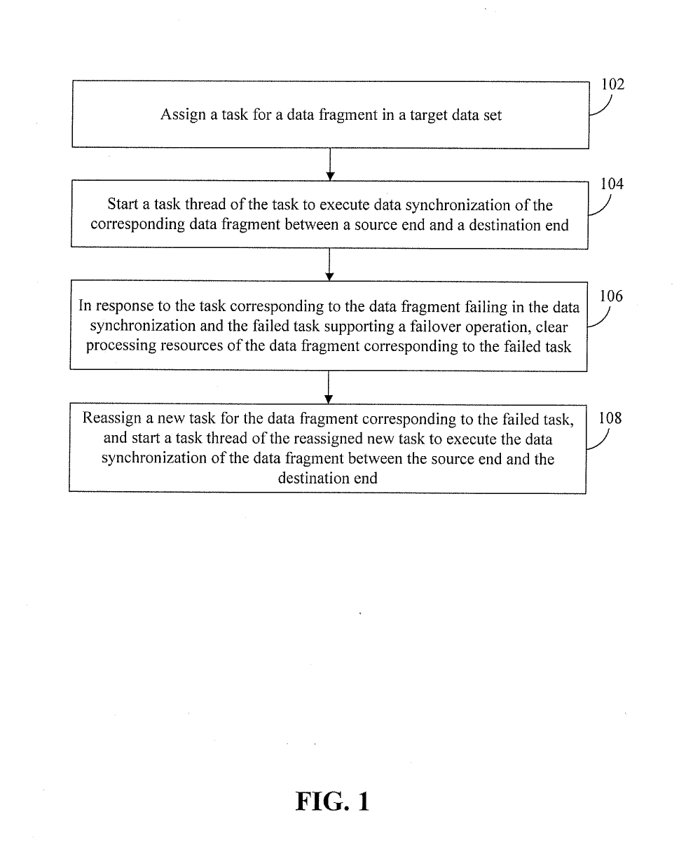

FIG. 1 illustrates a flowchart of an exemplary data synchronization method according to embodiments of the present application. The data synchronization method may include the following steps 102-108.

In step 102, a task can be assigned to each data fragment in a target data set respectively.

In step 104, a task thread of the task can be initiated to execute offline data synchronization of the corresponding data fragment between a source end and a destination end. When offline data synchronization is carried out between different databases/file systems, a data set to be synchronized can be referred to as a target data set. A source end and a destination end of the offline data synchronization may be set. A database/file system where the target data set is located is used as the source end, and a database/file system to which the target data set is to be synchronized is used as the destination end. The target data set may be considered as a set of business data, including a large amount of business data. Therefore, before offline synchronization is carried out on the target data set, the target data set may be divided into several data fragments in advance. A main thread executing the data synchronization can establish multiple tasks, and assign a data fragment to each task. Therefore, each data fragment corresponds to one task. Each task can correspond to a corresponding task thread, and therefore, a task thread can be executed for each data fragment of the target data set, and multiple task threads can be used synchronously to execute the offline data synchronization between the source end and the destination end. Therefore, data reading and writing operations can be carried out between the source end and the destination end.

In step 106, after it is determined that a task corresponding to any data fragment fails in synchronization and if it is determined that the failed task supports a failover operation, processing resources of the data fragment corresponding to the failed task are cleared.

In step 108, a new task can be reassigned to the data fragment corresponding to the failed task, and a task thread of the reassigned new task can execute the offline data synchronization of the data fragment between the source end and the destination end.

In the process that the task thread carries out the offline data synchronization on the data fragment, the task may fail in synchronizing the data fragment due to various reasons such as an unstable network, a timeout of writing data to the destination end, or the like. When a task has failed during processing due to some reasons, the data fragment may be moved to another component (such as a node, a progress, or a thread) for reprocessing. In some embodiments, whether the failed data fragment supports the failover operation may be determined according to an attribute of the destination end.

When the task that fails during synchronization is determined and it is determined that the failed task supports the failover operation, the data fragment corresponding to the failed task may be moved to another task thread for reprocessing. Before the data fragment corresponding to the failed task is moved, processing resources corresponding to the data fragment may be cleared to avoid the data fragment from being processed by two task threads simultaneously. For example, the task thread occupied by the data fragment can be released.

After the processing of resources corresponding to the failed data fragment has been cleared, a new task thread may be reassigned to the failed data fragment, and the reassigned new task thread can execute the offline data synchronization of the data fragment between the source end and the destination end. For example, offline data reading and writing operations can be carried out between the source end and the destination end.

In view of the above, a task can be assigned to each data fragment of a target data set, and a task thread of the task can be started to execute offline data synchronization of the corresponding data fragment between a source end and a destination end. If it is determined that a task corresponding to any data fragment has failed in synchronization and if it is determined that the failed task supports a failover operation, processing resources of the data fragment corresponding to the failed task are cleared, a task is reassigned to the data fragment corresponding to the failed task, and a task thread of the reassigned task is initiated to execute the offline data synchronization of the data fragment between the source end and the destination end. Therefore, the data fragment of the failed task is directly resynchronized, and it is unnecessary to reprocess the target data set, thereby saving resources and shortening the synchronization time.

Embodiments of the application further describes a failover-based offline data synchronization operation in detail.

The offline data synchronization according to embodiments of the present application may be applied to offline synchronization of DataX. DataX is a tool for exchanging data at a high speed between heterogeneous databases/file systems, implementing data exchange between any data processing systems (such as RDBMS, Hdfs, Local filesystem, or the like).DataX is constructed by using Framework+plug-in architecture. The Framework processes most technical problems in high-speed data exchange such as buffer, flow control, concurrence, and context loading, and provides a simple interaction between an interface and a plug-in. The plug-in can implement access to a data processing system. A running mode of DataX can be stand-alone. The data transmission process can be implemented in a single progress, and all operations are performed in a memory, no magnetic disk is read or written, and there is no Inter-Process Communication (IPC) either. DataX has an open frame, and a developer can develop a new plug-in within a very short time to support a new database/file system quickly. Therefore, the offline data synchronization operation can be described in detail by taking an example in which offline synchronization is executed by DataX.

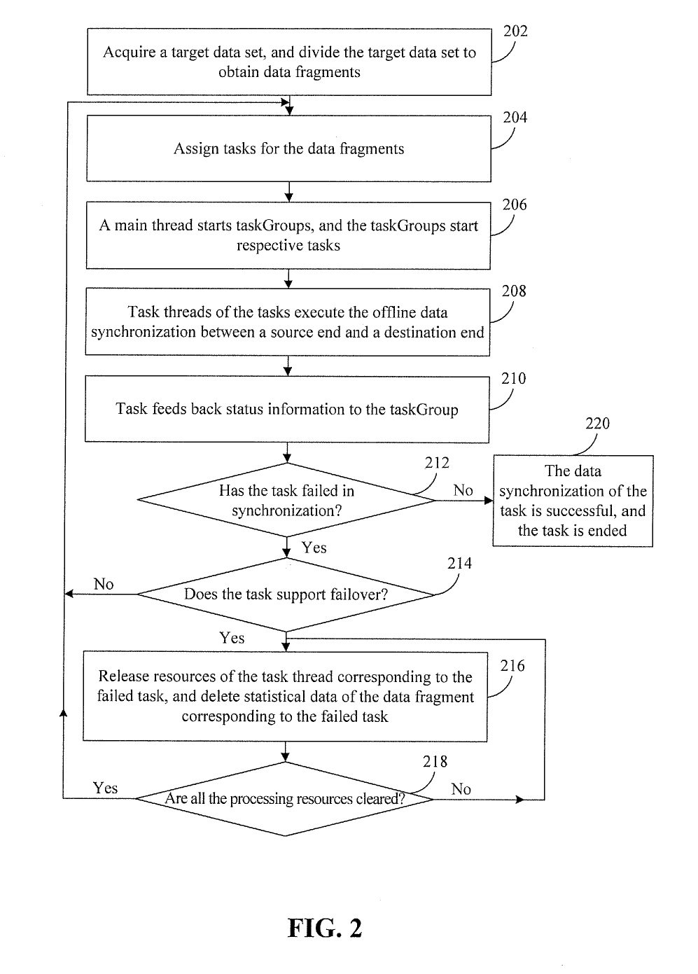

FIG. 2 illustrates a flowchart of another exemplary data synchronization method according to embodiments of the present application. The data synchronization method may specifically include the following steps 202-220.

In step 202, a target data set can be acquired and divided to obtain data fragments.

In step 204, tasks can be assigned to the data fragments.

In step 206, a main thread can start a group of tasks. The group of tasks can be referred to as a “taskGroup,” as shown in FIG. 2A.

In step 208, offline data synchronization can be executed between a source end and a destination end by task threads of the tasks.

Before the offline data synchronization is carried out between the source end and the destination end, a target data set is determined and divided into several data fragments to improve the efficiency of the offline synchronization. In some embodiments, the main thread executing the offline data synchronization can establish multiple taskGroups (i.e., multiple groups of tasks), and multiple tasks can be established in each task group. Therefore, the offline data synchronization may be executed in a manner of the task group. For example, a task can be assigned to each data fragment, and a synchronization processing can be carried out by using a task thread of the task. After assignment of the data fragment, the main thread can start each task group, the task group can start respective tasks of the group. Task threads of the tasks can each execute offline data synchronization between the source end and the destination end.

The task thread can include a read thread and a write thread. The read thread is used for reading data, and the write thread is used for writing data. The main thread can further assign a data buffer to each task, for storing read and written data temporarily. Therefore, when the offline data synchronization is carried out, data reading and data writing can be executed between the source end and the destination end through the read thread and the write thread respectively. Moreover, the data may be stored in a data buffer temporarily, thereby implementing the offline data synchronization.

In step 210, each task can feed back status information to the respective taskGroup.

In step 212, it is determined whether the task has failed in synchronization according to the status information.

When a task carries out data synchronization on the data fragment, the task can collect status information thereof and feed the status information back to the task group. The status information can include a processing result of the offline data synchronization on the data fragment. Therefore, the task can notify the task group whether the offline synchronization is successfully processed. A processing success message may be fed back if the processing is successful, and a processing failure message may be fed back if the processing fails. Therefore, it may be determined that the processing has failed according to the processing failure information in the status information.

In embodiments of the present application, when there is any abnormal information, processing failure information can be fed back. The abnormal information includes: source end abnormal information, destination end abnormal information, network abnormal information, and task thread abnormal information. And it can be determined, according to the processing failure information, that the task corresponding to the abnormal situation has failed in synchronization.

The source end abnormal information can be generated due to a source end abnormality (e.g., a data source being unavailable due to jitter).

The destination end abnormal information can be generated due to a destination end abnormality (e.g., the source end being closed due to a connection timeout caused by slow writing to the destination end).

The network abnormal information can be generated due to a network abnormality (e.g., network interruption).

The task thread abnormal information can be generated due to a task thread abnormality (e.g., a thread error).

When the offline data synchronization is carried out between the source end and the destination end, the task may fail due to an error in any step of the whole synchronization process. Therefore, corresponding processing failure information can be generated when abnormal information occurs because of any of the previously mentioned situations.

The task can generate corresponding processing failure information when any of the above abnormalities occurs. The task adds the processing failure information to the status information and feeds back the status information to the task group. The task group determines, according to the processing failure information, whether the task corresponding to the abnormal situation has failed during synchronization.

If it is determined that the synchronization has failed according to the status information, step 214 can be performed. if it is determined that the synchronization is successful according to the status information, step 220 can be performed.

In step 214, it can be determined whether the failed task supports failover according to a read/write feature of the destination end.

In some embodiments, for the failed task capable of supporting the failover, the data fragment corresponding to the failed task may be resynchronized. That is, reprocessing on the data fragment that has failed in synchronization can be supported. Therefore, it is unnecessary to resynchronize the whole target data set, thus saving resources and the synchronization time.

Whether the failed task can execute failover depends on the read/write feature of the destination end. When the read/write feature of the destination end is a temporary synchronization feature or an idempotent feature, it may be determined that the read/write feature of the destination end meets a failover condition. That is, the failed task can support the failover.

The temporary synchronization feature can include: writing synchronization data into a temporary region in a synchronization process; and after the synchronization is completed, validating the synchronization data after the synchronization data in the temporary region is moved into a fixed storage region through an operation instruction.

During execution of data synchronization between the source end and the destination end, when synchronization data is written into the destination end, the synchronization data is first written into a temporary area (e.g., a temporary buffer) for buffering. When synchronization of a data fragment is completed, the destination end can send an operation execution instruction (e.g., commit instruction), and then the synchronization data in the temporary area is moved to an actual production region (e.g., a fixed storage area), according to the commit instruction. The synchronization data becomes valid after the moving is completed.

For a destination end having the above feature (e.g., temporary synchronization feature), if the task fails, the destination end may execute failover without sending a commit instruction. For example, a task can be re-initiated to synchronize data to a new temporary area. It may be unnecessary to pay attention to the synchronization data in the temporary area corresponding to the failed task, because the destination end can automatically clear the synchronization data in the temporary area corresponding to the failed task, and the synchronization data may not be applied to production and may not be valid. Therefore, if the data is synchronized to the destination end having the temporary synchronization feature, the corresponding failed task can support failover.

The idempotent feature can indicate that a data writing operation supports an idempotent operation. For example, synchronization data of the destination end can be written in an idempotent manner. The effect of a plurality of executions is the same as the effect of one execution. Therefore, if writing is executed for multiple times in the process of data synchronization, data written later can overwrite the previous data, and the problem of data duplication will not occur. If the destination end has the idempotent feature, the corresponding task supports failover.

The above offline synchronization can be applied to the DataX, and when the task fails, it is accurately determined whether the task can support failover. Different plug-ins have different determination standards. When the destination end is an odpsWriter or mySQLWriter system, a writing mode thereof can be a replace mode. Therefore, the writing operation can be idempotent. Therefore, the destination end supports failover. In another example, the destination end in a put mode of Tairwriter can also support task failover. When the destination end is odpsWriter, no commit instruction is fed back in the data synchronization process, and synchronization data written to the destination end is in the temporary area. Therefore, the data is not valid, and failover can be executed.

Therefore, when it is determined whether a failed task supports failover according to the writing feature of the destination end, a supportFailover method may be implemented in the writer of the task. “true” or “false” can be returned according to the writing feature of the current destination end and a synchronization progress, to inform the task group of whether the task supports failover or not. If it is determined that the failed task supports failover, step 216 can be performed. If it is determined that the failed task does not support failover, the procedure returns to step 204 to resynchronize the target data set.

In step 216, resources of the task thread corresponding to the failed task are released, and statistical data of the data fragment corresponding to the failed task is deleted.

When the task group finds that the task fails and determines that the failed task supports failover, the task thread of the failed task can be interrupted, and statistical data can be cleared. Resources of the task thread corresponding to the failed task may be released. Therefore, the task thread corresponding to the failed task stops external reading and writing operations. Moreover, statistical data of the data fragment corresponding to the failed task can be deleted. The statistical data can include the number of synchronization records, the amount of synchronization data, and the like of the data fragment. Therefore, the number of synchronization records, the amount of synchronization data, and the like of the data fragment can be cleared.

In some embodiments of the present application, the releasing resources of the task thread corresponding to the failed task can include: clearing synchronization data stored in data buffers corresponding to the read thread and the write thread; and canceling occupation of the read thread and the write thread by the data fragment corresponding to the failed task.

The task thread uses the read thread to execute a reading operation of the synchronization data, and uses the write thread to execute a writing operation of the synchronization data. When resources of the task thread are released, the current reading and writing operations of the read thread and the write thread may be stopped. Meanwhile, synchronization data stored in data buffers corresponding to the read thread and the write thread can be cleared, and occupation of the read thread and the write thread by the data fragment corresponding to the failed task can be canceled. Therefore, the data fragment is not processed by the task thread any longer.

In step 218, it is determined whether all the processing resources of the data fragment corresponding to the failed task are cleared.

In some embodiments, when the task fails during synchronization, it may be necessary to release all the processing resources of the task, to ensure that the failed task has been terminated when the failover is executed and a reassigned task executes synchronization, and ensure that the same data fragment will not be processed by two tasks simultaneously.

Moreover, after the statistical data is cleared, statistics on data can be made again when the reassigned task executes synchronization. Therefore, it should be ensured that all the resources of the failed task have been released, guaranteeing that data finally written into the destination end is not lost or repeated. Resources can be cleared by interrupting the read and write threads of the failed task and by setting memory channels that are operated by the read and write threads to be invalid. The task group will reassign a new task for the data fragment and start the reassigned new task to execute the data synchronization only after determining that the failed task has stopped completely.

Therefore, after completing clearing of the processing resources, the failed task can report to the task group whether its read and write threads have been ended and whether memory resources have been released. Therefore, the task group will determine, on the basis of the feedback of the failed task, whether clearing of the processing resources is finished.

If the clearing of the processing resources is finished, step 204 can be performed. If no, the clearing of the processing resources is not finished, step 216 can be performed to continue to clear resources.

After the clearing of the processing resources is finished, failover may be executed for the failed task. Therefore, the procedure returns to step 204 to reassign a new task for the data fragment corresponding to the failed task. The reassigned new task can carry out data synchronization on the data fragment failed in synchronization, until the data synchronization succeeds, and the task is ended.

In step 220, the data synchronization of the task is successful, and the task is ended. It is determined that the data synchronization of the task succeeds in synchronization according to the status information, and the task is ended.

Therefore, when the task corresponding to the data fragment fails in processing, after it is determined that the failed task supports failover based on the read/write feature of the destination end, the failover may be executed. That is, a new task is reassigned for the data fragment to re-execute the synchronization. Therefore, the task-level failover can be executed, and it is unnecessary to resynchronize the whole target data set, thereby improving the synchronization efficiency.

There exists a problem that a plug-in cannot implement breakpoint resume in the offline synchronization. For example, in a relational database, source end data storage in the offline synchronization cannot support location setting, and if there is an error in the middle of reading in the data fragment synchronization, data cannot be easily and conveniently drawn again from the error location for reading. In this example, the task-level failover is employed to draw data from the source again, thereby solving the location problem.

There exists a problem that retry of a plug-in in the offline synchronization does not cover all data. The existing plug-in has a fine retry granularity, and generally a captured abnormality is submitted for a single record or a batch to carry out retry. Because the whole life cycle of the task includes a lot of operation steps, there may be missing points, causing omission of retry. By the application of the task-level failover, a data fragment can be resynchronized, thereby solving the above problem.

By using the task-level failover, the data fragment may be rescheduled to different machines, and a task is reassigned, thereby resuming data synchronization automatically.

It should be noted that, for ease of description, the method according to embodiments of the application is described as a combination of a series of actions. However, it is appreciated that the embodiments of the present application are not limited to the action order described herein. Some steps may be performed in other orders or simultaneously according to embodiments of the present application. Furthermore, in embodiments of the application, not all actions involved therein are necessarily required to perform the above method.

Embodiments of the application further provide a data synchronization system.

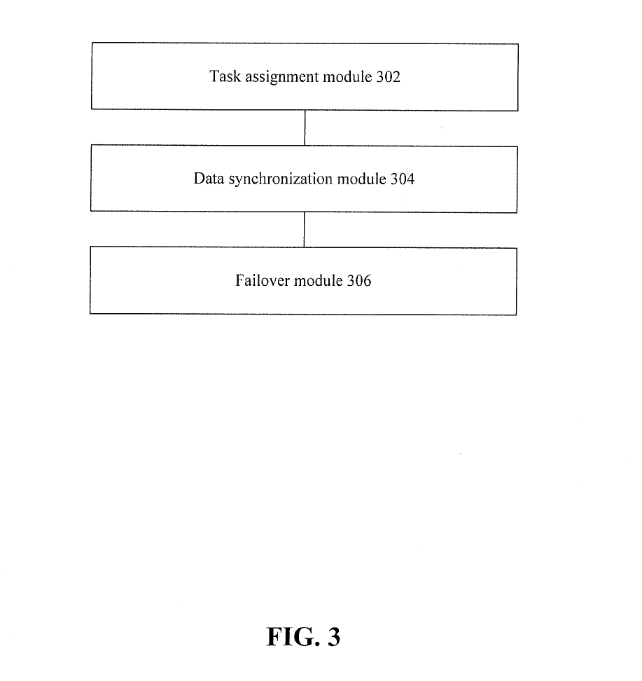

FIG. 3 illustrates a structural block diagram of a data synchronization system according to embodiments of the present application. The data synchronization system may include the following modules 302-306.

A task assignment module 302 can be configured to assign a task for each data fragment in a target data set respectively; and reassign a new task for a data fragment corresponding to a failed task.

A data synchronization module 304 can be configured to start a task thread of the task, and execute offline data synchronization of the corresponding data fragment between a source end and a destination end.

A failover module 306 can be configured to, after it is determined that a task corresponding to any data fragment has failed during synchronization and if it is determined that the failed task supports a failover operation, clear processing resources of the data fragment corresponding to the failed task; and trigger the task assignment module to reassign a second task for the data fragment corresponding to the failed first task and start a task thread of the reassigned second task to execute data synchronization of the data fragment between the source end and the destination end.

For example, task assignment module 302 assigns a task for each data fragment of a target data set respectively, and then data synchronization module 304 starts a task thread of the task, and executes offline data synchronization of the corresponding data fragment between a source end and a destination end. If a task corresponding to any data fragment has failed during synchronization, failover module 306 clears, after it is determined that a task corresponding to any data fragment has failed during synchronization and if it is determined that the failed task supports a failover operation, processing resources of the data fragment corresponding to the failed task; and triggers task assignment module 302 to reassign a new task for the data fragment corresponding to the failed task. Data synchronization module 304 starts a task thread of the reassigned new task to execute offline data synchronization of the data fragment between the source end and the destination end. After synchronization of the data fragments is successful, the offline data synchronization of the target data set is completed.

In view of the above, a task is assigned for each data fragment of a target data set respectively, a task thread of the task is started, and offline data synchronization of the corresponding data fragment is executed between a source end and a destination end. If it is determined that a task corresponding to any data fragment has failed during synchronization and it is determined that the failed task supports a failover operation, that is, task-level failover can be executed, processing resources of the data fragment corresponding to the failed task are cleared, a new task is reassigned for the data fragment corresponding to the failed task, and a task thread of the reassigned new task is started to execute offline data synchronization of the data fragment between the source end and the destination end. Therefore, the data fragment of the failed task is directly resynchronized, and it is unnecessary to reprocess the whole target data set, thereby saving resources and shortening the synchronization time.

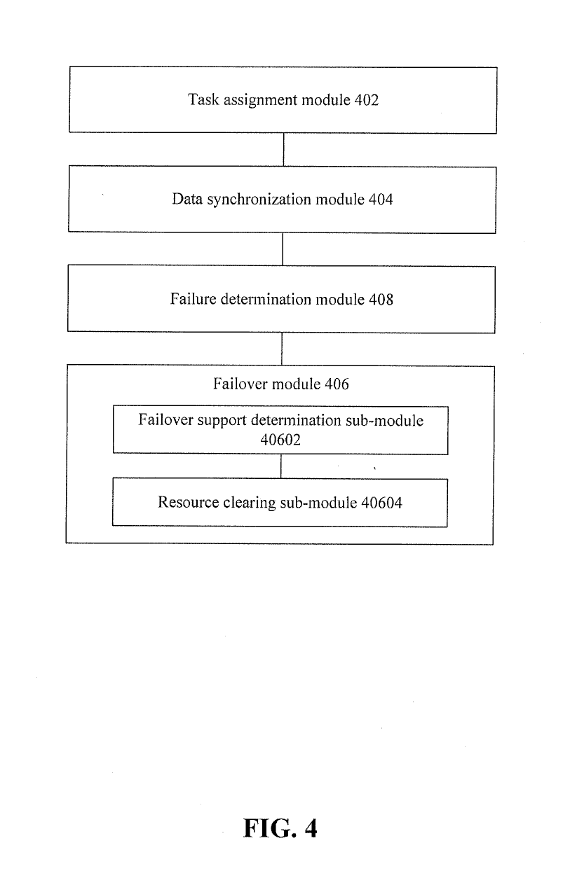

FIG. 4 illustrates a structural block diagram of another exemplary data synchronization system according to embodiments of the present application. The data synchronization system may include the following modules 402-406.

A task assignment module 402 can be configured to assign a task for each data fragment in a target data set respectively.

A data synchronization module 404 can be configured to start a task thread of the task, and execute offline data synchronization of the corresponding data fragment between a source end and a destination end.

A failover module 406 can be configured to, after it is determined that a task corresponding to any data fragment has failed during synchronization and if it is determined that the failed task supports a failover operation, clear processing resources of the data fragment corresponding to the failed task, and trigger task assignment module 402 to reassign a new task for the data fragment corresponding to the failed task. Data synchronization module 404 can be further configured to start a task thread of the reassigned new task to execute offline data synchronization of the data fragment between the source end and the destination end.

In some embodiments, the failover module 406 further includes: a failover support determination sub-module 40602 and a resource clearing sub-module 40604.

Failover support determination sub-module 40602 can be configured to, when it is determined that a read/write feature of the destination end meets a failover condition, determine that the failed task supports a failover operation. Failover support determination sub-module 40602 can be further configured to, when the read/write feature of the destination end is a temporary synchronization feature or an idempotent feature, judge that the read/write feature of the destination end meets the failover condition. The temporary synchronization feature includes a feature of: writing synchronization data into a temporary region in a synchronization process, and after the synchronization is completed, validating the synchronization data after the synchronization data in the temporary region is moved into a fixed storage region through an operation instruction. The idempotent feature can include a data writing operation supporting an idempotent operation.

Resource clearing sub-module 40604 can be configured to carry out resource releasing on the task thread corresponding to the failed task, and delete statistical data of the data fragment corresponding to the failed task. Resource clearing sub-module 40604 can be further configured to clear synchronization data stored in data buffers corresponding to the read thread and the write thread; and cancel occupation of the read thread and the write thread by the data fragment corresponding to the failed task. Resource clearing sub-module 40604 is further configured to stop the task thread from executing offline data synchronization between the source end and the destination end.

In some embodiments of the disclosure, the data synchronization system further includes a failure determination module 408 configured to provide, when there is any piece of abnormal information, feedback processing failure information. The abnormal information includes: source end abnormal information, destination end abnormal information, network abnormal information, and task thread abnormal information. The data synchronization system can determine, according to the processing failure information, that a task corresponding to the abnormal situation has failed during synchronization.

That is, task assignment module 402 assigns a task for each data fragment of the target data set respectively. The data synchronization module 404 starts a task thread of any task, and executes offline data synchronization of the corresponding data fragment between the source end and the destination end. The failure determination module 408 is configured to, when there is any piece of abnormal information, feedback processing failure information, wherein the abnormal information includes: source end abnormal information, destination end abnormal information, network abnormal information, and task thread abnormal information; and determine, according to the processing failure information, that a task corresponding to the abnormal situation fails in synchronization. Failover module 406 can be configured to, after it is determined that a task corresponding to any data fragment has failed during synchronization and if it is determined that the failed task supports a failover operation, clear processing resources of the data fragment corresponding to the failed task; and trigger task assignment module 402 to reassign a new task for the data fragment corresponding to the failed task. Data synchronization module 404 can start a task thread of the reassigned new task to execute offline data synchronization of the data fragment between the source end and the destination end.

Therefore, when the task corresponding to the data fragment fails in processing, after it is determined that the failed task supports failover based on the read/write feature of the destination end, the failover may be executed. Therefore, a new task can be reassigned to the data fragment to re-execute the synchronization. Therefore, the task-level failover is executed, and it may be unnecessary to resynchronize the whole target data set, thereby improving the synchronization efficiency.

There exists a problem that a plug-in cannot implement breakpoint resume in the offline synchronization. For example, in a typical relational database, source end data storage in the offline synchronization cannot support location setting, and if there is an error in the middle of reading in the data fragment synchronization, data cannot be easily and conveniently drawn again from the error location for reading. This embodiment employs the task-level failover to draw data from the source again, thereby solving the location problem.

There exists a problem that retry of a plug-in in the offline synchronization does not cover all data. The existing plug-in has a fine retry granularity, and generally a captured abnormality is submitted for a single record or a batch to carry out retry. Because the whole life cycle of the task includes many operation steps, there may be missing points, causing omission of retry. By the application of the task-level failover, a data fragment can be resynchronized, thereby solving the above problem.

By using the task-level failover, the data fragment may be rescheduled to different machines, and a new task can be reassigned, thereby resuming data synchronization automatically.

The apparatus embodiment can provide functionality similar to the method embodiment, so it is described simply, and for related parts, reference may be made to the descriptions of the parts in the above method.

The embodiments of this specification are described progressively, each embodiment emphasizes a part different from other embodiments, and identical or similar parts of the embodiments may be obtained with reference to each other.

It is appreciated that the embodiments of the embodiments of the present application may be provided as a method, an apparatus, or a computer program product. Therefore, embodiments of the present application may be implemented as a complete hardware embodiment, a complete software embodiment, or an embodiment combining software and hardware. Moreover, embodiments of the present application may be a computer program product implemented on one or more computer usable storage media (including, but not limited to, a magnetic disk memory, a CD-ROM, an optical memory, and the like) including computer usable program codes.

In some embodiments, the computer device includes one or more processors (CPUs), an input/output interface, a network interface, and a memory. The memory may include a computer readable medium such as a volatile memory, a Random Access Memory (RAM) and/or a non-volatile memory, e.g., a Read-Only Memory (ROM) or a flash RAM. The memory is an example of the computer readable medium. The computer readable medium includes non-volatile and volatile media as well as movable and non-movable media, and can implement information storage by means of any method or technology. Information may be a computer readable instruction, a data structure, and a module of a program or other data. An example of the storage medium of a computer includes, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and can be used to store information accessible to a computing device. According to the definition herein, the computer readable medium does not include transitory media, such as a modulated data signal and a carrier.

Embodiments of the present application are described with reference to flowcharts and/or block diagrams according to the method, terminal device (system) and computer program product according to the embodiments of the present application. It is appreciated that a computer program instruction may be used to implement each process and/or block in the flowcharts and/or block diagrams and combinations of processes and/or blocks in the flowcharts and/or block diagrams. The computer program instructions may be provided to a universal computer, a dedicated computer, an embedded processor or a processor of another programmable data processing terminal device to generate a machine, such that the computer or a processor of another programmable data processing terminal device executes an instruction to generate an apparatus configured to implement functions designated in one or more processes in the flowcharts and/or one or more blocks in the block diagrams.

The computer program instructions may also be stored in a computer readable storage that can instruct a computer or another programmable data processing terminal device to work in a specific manner, such that the instruction stored in the computer readable storage generates an article of manufacture including an instruction apparatus. The instruction apparatus implements a designated function in one or more processes in the flowcharts and/or one or more blocks in the block diagrams.

The computer program instructions may also be loaded in a computer or another programmable data processing terminal device, such that a series of operation steps are executed on the computer or another programmable terminal device to generate computer implemented processing. Therefore, the instructions executed in the computer or another programmable terminal device provide steps for implementing designated functions in one or more processes in the flowcharts and/or one or more blocks in the block diagrams.

It is appreciated that other variations and modifications can be made to embodiments described above. Therefore, the appended claims are intended to be explained as including the preferred embodiments and all variations and modifications falling within the scope of the embodiments of the present application.

Finally, it should be further noted that, in this text, the relation terms such as first and second are merely used to distinguish one entity or operation from another entity or operation, and do not necessarily require or imply that the entities or operations have this actual relation or order. Moreover, the term “include”, “comprise” or other variations thereof are intended to cover non-exclusive inclusion, so that a process, a method, an article, or a terminal device including a series of elements not only includes the elements, but also includes other elements not clearly listed, or further includes inherent elements of the process, method, article or terminal device. In a case without any more limitations, an element defined by “including a/an . . . ” does not exclude that the process, method, article or terminal device including the element further has other identical elements.

A data synchronization method and a data synchronization system provided in the present application are described in detail, and the principles and implementations of the present application are described by applying specific examples in this text. The above description on the embodiments is merely used to help understand the method of the present application and core ideas thereof Meanwhile, it is appreciated that modifications may be made to the specific implementations and application scopes according to the idea of the present application. Therefore, the content of the specification should not be construed as any limitation to the present application.

1. A data synchronization method, comprising:
assigning a first task for a data fragment in a target data set;
starting a task thread of the first task to execute data synchronization of the corresponding data fragment between a source end and a destination end;
determining if the first task corresponding to the data fragment fails in the data synchronization; and
in response to the first task corresponding to the data fragment failing in the data synchronization, reassigning a second task for the data fragment corresponding to the failed first task, and starting a task thread of the reassigned second task to execute the data synchronization of the data fragment between the source end and the destination end.

2. The method according to claim 1, further comprising determining if the first task supports a failover operation, wherein determining if the first task supports the failover operation comprises:
in response to at least one of a read feature and a write feature of the destination end meeting a failover condition, determining that the failed first task supports the failover operation.

3. The method according to claim 2, further comprising:
in response to at least one of the read feature and the write feature of the destination end being a temporary synchronization feature or an idempotent feature, determining that the read/write feature of the destination end meets the failover condition,
wherein the temporary synchronization feature comprises a feature of: writing synchronization data into a temporary region in a synchronization process, and after the synchronization is completed, validating the synchronization data after the synchronization data in the temporary region is moved into a fixed storage region through an operation instruction; and
the idempotent feature comprises a data writing operation supporting an idempotent operation.

4. The method according to claim 1, further comprising:
releasing resources of the task thread corresponding to the failed firs task, and deleting statistical data of the data fragment corresponding to the failed first task.

5. The method according to claim 4, wherein the task thread comprises a read thread and a write thread; and releasing resources of the task thread corresponding to the failed first task further comprises:
clearing synchronization data stored in data buffers corresponding to the read thread and the write thread; and
canceling occupation of the read thread and the write thread by the data fragment corresponding to the failed first task.

6. The method according to claim 4, further comprising:
stopping the task thread from executing the data synchronization between the source end and the destination end.

7. The method according to claim 1, further comprising:
detecting abnormal information, wherein the abnormal information comprises: source end abnormal information, destination end abnormal information, network abnormal information, and task thread abnormal information;
in response to the detected abnormal information, feeding back processing failure information; and
determining, according to the processing failure information, that a task corresponding to the abnormal information fails in the data synchronization.

8. A data synchronization system, comprising:
a task assignment module configured to assign a first task for a data fragment in a target data set; and reassign a task for a data fragment corresponding to a failed task;
a data synchronization module configured to start a task thread of the first task to execute data synchronization of the corresponding data fragment between a source end and a destination end; and
a failover module configured to, determine if the first task corresponding to the data fragment fails in the data synchronization, in response to the first task corresponding to the data fragment failing in the data synchronization, trigger the task assignment module to reassign a second task for the data fragment corresponding to the failed first task and start a task thread of the reassigned second task to execute data synchronization of the data fragment between the source end and the destination end.

9. The system according to claim 8, wherein the failover module comprises:
a failover support determination sub-module configured to, in response to at least one of a read feature and a write feature of the destination end meeting a failover condition, determine that the failed first task supports a failover operation.

10. The system according to claim 9, wherein
the failover support determination sub-module is further configured to, in response to at least one of the read feature and the write feature of the destination end being a temporary synchronization feature or an idempotent feature, determine that at least one of the read feature and the write feature of the destination end meets the failover condition, wherein the temporary synchronization feature comprises a feature of: writing synchronization data into a temporary region in a synchronization process, and after the synchronization is completed, validating the synchronization data after the synchronization data in the temporary region is moved into a fixed storage region through an operation instruction; and the idempotent feature comprises a data writing operation supporting an idempotent operation.

11. The system according to claim 8, wherein the failover module comprises:
a resource clearing sub-module configured to release resources of the task thread corresponding to the failed first task and to delete statistical data of the data fragment corresponding to the failed first task.

12. The system according to claim 11, wherein
the resource clearing sub-module is further configured to clear synchronization data stored in data buffers corresponding to the read thread and the write thread; and cancel occupation of the read thread and the write thread by the data fragment corresponding to the failed task.

13. The system according to claim 11, wherein
the resource clearing sub-module is further configured to stop the task thread from executing the data synchronization between the source end and the destination end.

14. The system according to claim 8, further comprising a failure determination module, configured to:
detect abnormal information, wherein the abnormal information comprises: source end abnormal information, destination end abnormal information, network abnormal information, and task thread abnormal information;
in response to the detected abnormal information, feedback processing failure information; and determine, according to the processing failure information, that a task corresponding to the abnormal information fails in the data synchronization.

15. A non-transitory computer readable medium that stores a set of instructions that is executable by at least one processor of a computing system to cause the computing system to perform a data synchronization method, the method comprising
assigning a first task for a data fragment in a target data set;
starting a task thread of the first task to execute data synchronization of the corresponding data fragment between a source end and a destination end;
determining if the first task corresponding to the data fragment fails in the data synchronization; and
in response to the first task corresponding to the data fragment failing in the data synchronization, reassigning a second task for the data fragment corresponding to the failed first task, and starting a task thread of the reassigned second task to execute the data synchronization of the data fragment between the source end and the destination end.

16. The non-transitory computer readable medium according to claim 15, wherein the set of instructions is executable by at least one processor of the computing system to further perform:
determining the first task supports a failover operation, in response to at least one of a read feature and a write feature of the destination end meeting a failover condition.

17. The non-transitory computer readable medium according to claim 16, wherein the set of instructions is executable by at least one processor of the computing system to further perform:
in response to at least one of the read feature and the write feature of the destination end being a temporary synchronization feature or an idempotent feature, determining that the read/write feature of the destination end meets the failover condition,
wherein the temporary synchronization feature comprises a feature of: writing synchronization data into a temporary region in a synchronization process, and after the synchronization is completed, validating the synchronization data after the synchronization data in the temporary region is moved into a fixed storage region through an operation instruction; and
the idempotent feature comprises a data writing operation supporting an idempotent operation.

18. The non-transitory computer readable medium according to claim 15, wherein the set of instructions is executable by at least one processor of the computing system to further perform:
releasing resources of the task thread corresponding to the failed first task, and
deleting statistical data of the data fragment corresponding to the failed first task.

19. The non-transitory computer readable medium according to claim 18, wherein the task thread comprises a read thread and a write thread, and the set of instructions is executable by at least one processor of the computing system to perform releasing resources of the task thread corresponding to the failed first task by:
clearing synchronization data stored in data buffers corresponding to the read thread and the write thread; and
canceling occupation of the read thread and the write thread by the data fragment corresponding to the failed first task.

20. (canceled)

21. The non-transitory computer readable medium according to claim 15, wherein the set of instructions is executable by at least one processor of the computing system to perform:
detecting abnormal information, wherein the abnormal information comprises: source end abnormal information, destination end abnormal information, network abnormal information, and task thread abnormal information;
in response to the detected abnormal information, feeding back processing failure information; and
determining, according to the processing failure information, that a task corresponding to the abnormal information fails in the data synchronization.
